(19) United States
(12) Patent Application Publication
(10) Pub. No.: US 2023/0114403 A1
(43) Pub. Date: Apr. 13, 2023

(54) CONTRACT METHOD AND INFORMATION PROCESSING APPARATUS

(71) Applicant: FUJITSU LIMITED, Kawasaki-shi (JP)

(72) Inventors: Toshihiro Shimizu, Kawasaki (JP); Akihito Nakamura, Shinagawa (JP); Akihiro Kuwabara, Meguro (JP); Motohiro Kosaki, Kawasaki (JP)

(73) Assignee: FUJITSU LIMITED, Kawasaki-shi (JP)

(21) Appl. No.: 17/876,828

(22) Filed: Jul. 29, 2022

(30) Foreign Application Priority Data
Oct. 13, 2021 (JP) 2021-168195

(51) Int. Cl. G06Q 40/04

(52) U.S. Cl. CPC G06Q 40/04

(57) ABSTRACT

A non-transitory computer-readable recording medium stores a program for causing a computer to execute a process, the process includes setting, based on a sell order count included in information on a sell order, a first array that has elements corresponding to a first section of sell order counts with which a contract is available and a second section of sell order counts with which a contract is unavailable, setting, based on a buy order count included in information on a buy order, a second array that has elements corresponding to a third section of buy order counts with which a contract is available and a fourth section of buy order counts with which a contract is unavailable, and identifying sell orders and buy orders to be contract targets based on the information set in the first array and the second array.

### CROSS-REFERENCE TO RELATED APPLICATION

This application is based upon and claims the benefit of priority of the prior Japanese Patent Application No. 2021-168195, filed on Oct. 13, 2021, the entire contents of which are incorporated herein by reference.

### FIELD

The embodiments discussed herein are related to a contract method and an information processing apparatus.

### BACKGROUND

In a securities market, establishment of trading such as stock trading is called a “contract”. For example, a state in which conditions of a user who makes a sell order and a user who makes a buy order are matched and trading is established is referred to as a contract. In a case where a user makes an order (a sell order or a buy order), the user makes the order under a condition that a contract of a total amount is made or a contract of a certain count is made, in some cases.

A minimum limit contract count, which is a condition set for an order, is referred to as a “minimum contract count”. For example, in a case where there is a sell order having an order count “N” with a condition of a minimum contract count “M”, and there is a buy order having an order count equal to or greater than the order count “M”, trading is established. For such matching between the sell order and the buy order, there is a related art for obtaining a contract by dynamic programming.

In a process of identifying orders as contract targets by using the dynamic programming in the related art, a Bool (T, F) array a is prepared for managing each of the sell order and the buy order, and orders as contract targets that maximize a contract count are identified.

The Bool (T, F) array a is referred to as an “array a”. An index i equal to or greater than 0 is set for the array a, and ‘T’ or “F” is set for an element corresponding to the index i of the array a. A case where the element corresponding to the index i in the array a is “T” means that there is an order of an order count i. A case where the element corresponding to the index i in the array a is “F” means that there is no order of the order count i. “T” is an example of a registration symbol.

The case where the element of the index i in the array a is ‘T’ is indicated by a[i]=T. The case where the element of the index i in the array a is “F” is indicated by a[i]=F.

An array a storing information on a sell order is referred to as a “(sell) array a”, and an array a storing information on a buy order is referred to as a “(buy) array a”.

FIG. 20 is a diagram (1) illustrating a process on an array in a case where a sell order is accepted in the related art, and illustrates a state of the (sell) array a in a case where the sell order is accepted. In the related art, an information processing apparatus sets a[i+x]=T in a case where a[i]=T and a sell order of an order count x is accepted.

An initial state of the (sell) array a is illustrated in step S100. In the initial state of the (sell) array a, a[0]=T, and all other elements are “F”.

In a case where a sell order having an order count 3 is accepted, the state of the (sell) array a is as illustrated in step S101. In the related art, since the (sell) array a is a[0]=T, the information processing apparatus sets a[0+3]=T.

Next, in a case where an order having an order count 5 is accepted, the state of the (sell) array a is as illustrated in step S102. In the related art, since the (sell) array a is a[0]=T, the information processing apparatus sets a[0+5]=T. In the related art, since the (sell) array a is a[3]=T, the information processing apparatus sets a[3+5]=T.

An index in which an element of the (sell) array a is T indicates a matchable contract quantity. For example, in the state of the (sell) array a in step S102 in FIG. 20, the element of the index i=8 is “T”, and “8” is a quantity for which contracts of a total amount of the order count “3” and the order count “5” are made.

FIG. 21 is a diagram illustrating an example of an array in a case where a buy order is accepted in the related art, and illustrates a state of a (buy) array a in a case where the buy order is accepted. In the related art, in the same manner as the process for the (sell) array a in a case where the sell order is accepted described with reference to FIG. 20, the information processing apparatus sets a[i+x]=T in a case where a[i]=T and a buy order of the order count x is accepted. In the initial state of the (buy) array a, a[0]=T, and all other elements are “F”.

For example, in a case where a buy order having an order count 2, a buy order having an order count 3, and a buy order having an order count 6 are accepted in this order, the state of the (buy) array a is as illustrated in FIG. 21. For example, a[0]=T, a[2]=T, a[3]=T, a[5]=T, a[6]=T, a[8]=T, a[9]=T, and a[11]=T, and the other elements are “F”.

The information processing apparatus compares the (sell) array a of the sell orders described with reference to FIG. 20 and the (buy) array a described with reference to FIG. 21, and identifies a maximum matchable contract quantity.

FIG. 22 is a diagram illustrating an example of a process of calculating a contract count in the related art. In the related art, the information processing apparatus compares the (sell) array a with the (buy) array a, and identifies the largest index among indices in which both an element of the (sell) array a and an element of the (buy) array a are “T”, as a maximum contract count. In the example illustrated in FIG. 22, since the largest index among the indices in which both the element of the (sell) array a and the element of the (buy) array a are ‘T’ is “8”, the information processing apparatus calculates the maximum matchable contract quantity as “8” in the related art.

Next, a process in which the information processing apparatus identifies orders to be contract targets in the related art will be described. In the related art, in a case of accepting an order and setting “T” in an element of the array a for the first time, the information processing apparatus registers auxiliary information indicating an order reception sequence (order sequence) and a quantity (order count) for each index, and thus it is possible to identify orders as contract targets.

FIG. 23 is a diagram (2) illustrating a process on an array in a case where a sell order is accepted in the related art. Although an initial state of the (sell) array a is not illustrated in FIG. 23, the initial state of the (sell) array a corresponds to the state of the (sell) array a in step S100 described with reference to FIG. 20. In the related art, the information processing apparatus does not give auxiliary information to an element of “T” in the initial state.

First (order reception sequence=1), in a case where a sell order having an order count 2 is accepted, the state of the (sell) array a is as illustrated in step S111. In the related art, since the (sell) array a is a[0]=T in the initial state, the information processing apparatus sets a[0+2]=T. Auxiliary information indicating a sequence number and a quantity is registered in the index i=2. A sequence number “1” and a quantity “2” are set in the auxiliary information.

Next (order reception sequence=2), in a case where a sell order having an order count 3 is accepted, the state of the (sell) array a is as illustrated in step S112. In the related art, since the (sell) array a is a[0]=T, the information processing apparatus sets a[0+3]=T, and registers auxiliary information to the index i=3. A sequence number “2” and a quantity “3” are set in the auxiliary information.

In the related art, since the (sell) array a is a[2]=T, the information processing apparatus sets a[2+3]=T, and registers auxiliary information to the index i=5. A sequence number “2” and a quantity “3” are set in the auxiliary information.

Although not illustrated, also in a case where a buy order is accepted, the information processing apparatus sets “T” in an element of the (buy) array a, and registers auxiliary information in an index in the same manner as in FIG. 23, in the related art.

FIG. 24 is a diagram (1) illustrating a process of identifying orders to be contract targets in the related art. In FIG. 24, in the related art, the information processing apparatus sequentially accepts an order having an order count “3” and an order having an order count “5”, as sell orders. In the related art, the information processing apparatus sequentially accepts, as buy orders, an order having an order count “2”, an order having an order count “3”, and an order having an order count “6”.

In the related art, when sequentially accepting the sell orders, the information processing apparatus executes a process on the (sell) array a in a case where the sell order is accepted, thereby setting the (sell) array a to the state as illustrated in FIG. 24. An element of the index i=0, 3, 5, and 8 of the (sell) array a is ‘T’, and the other elements are “F”. ‘T’ of the index i=0 is set in an initial state.

In the related art, the information processing apparatus sets auxiliary information of a sequence number “1” and a quantity “3” to the index i=3 of the (sell) array a. In the related art, the information processing apparatus sets auxiliary information of a sequence number “2” and a quantity “5” to the index i=5 of the (sell) array a. In the related art, the information processing apparatus sets auxiliary information of a sequence number “2” and a quantity “5” to the index i=8 of the (sell) array a.

In the related art, when sequentially accepting the buy orders, the information processing apparatus executes a process on the (buy) array a in a case where the buy order is accepted, thereby setting the (buy) array a to the state as illustrated in FIG. 24. An element of the index i=0, 2, 3, 5, 6, 8, 9, and 11 in the (buy) array a is “T”, and the other elements are “F”. “T” of the index i=0 is set in an initial state.

In the related art, the information processing apparatus sets auxiliary information of a sequence number “1” and a quantity “2” to the index i=2 of the (buy) array a. In the related art, the information processing apparatus sets auxiliary information of a sequence number “2” and a quantity “3” to the index i=3 of the (buy) array a. In the related art, the information processing apparatus sets auxiliary information of a sequence number “2” and a quantity “3” to the index i=5 of the (buy) array a.

In the related art, the information processing apparatus sets auxiliary information of a sequence number “3” and a quantity “6” to the index i=6 of the (buy) array a. In the related art, the information processing apparatus sets auxiliary information of a sequence number “3” and a quantity “6” to the index i=8 of the (buy) array a. In the related art, the information processing apparatus sets auxiliary information of a sequence number “3” and a quantity “6” to the index i=9 of the (buy) array a. In the related art, the information processing apparatus sets auxiliary information of a sequence number “3” and a quantity “6” to the index i=11 of the (buy) array a.

In the related art, the information processing apparatus compares the (sell) array a with the (buy) array a, and calculates the largest index among indices in which both an element of the (sell) array a and an element of the (buy) array a are “T”, as a contract count. In the example illustrated in FIG. 24, the largest index among the indices in which both the element of the (sell) array a and the element of the (buy) array a are “T” is the index i=8. For this reason, the information processing apparatus in the related art sets a contract count to “8”.

In the related art, after calculating the contract count, the information processing apparatus identifies orders as contract targets, based on the auxiliary information set in the array a. In the related art, in a case of a contract with the contract count i₀, the information processing apparatus sets an initial value of the index i=i₀, and repeatedly executes the following process until i=0.

In the related art, the process repeated by the information processing apparatus is the following process. In the related art, the information processing apparatus treats an order with a[i]=T as a contract target. In the related art, next, the information processing apparatus identifies the quantity α included in the auxiliary information set in a[i], and updates the index i by i=i−α.

Based on the “(sell) array a” in FIG. 24, a process in which the information processing apparatus identifies sell orders for a contract in the related art will be described.

The information processing apparatus treats, as a contract target, an order corresponding to the auxiliary information set to the index i=8 corresponding to the contract count “8”. The auxiliary information having the index i=8 corresponds to the order having the sequence number “2” and the quantity “5”. The information processing apparatus acquires the quantity α=5 included in the auxiliary information, and updates the index i=8-5=3.

The information processing apparatus treats an order corresponding to the auxiliary information set to the index i=3 as a contract target. The auxiliary information having the index i=3 corresponds to the order having the sequence number “1” and the quantity “3”. The information processing apparatus acquires the quantity α=3 included in the auxiliary information of the index i=3, and updates the index i=3-3=0. Since the index i=0, the information processing apparatus ends the process.

Based on the “(buy) array a” in FIG. 24, a process in which the information processing apparatus identifies buy orders for a contract in the related art will be described.

The information processing apparatus treats, as a contract target, an order corresponding to the auxiliary information set to the index i=8 corresponding to the contract count “8”. The auxiliary information having the index i=8 corresponds to the order having the sequence number “3” and the quantity “6”. The information processing apparatus acquires the quantity α=6 included in the auxiliary information of the index i=8, and updates the index i=8−6=2.

The information processing apparatus treats an order corresponding to the auxiliary information set to the index i=2 as a contract target. The auxiliary information having the index i=2 corresponds to the order having the sequence number “1” and the quantity “2”. The information processing apparatus acquires the quantity α=2 included in the auxiliary information of the index i=2, and updates the index i=2-2=0. Since the index i=0, the information processing apparatus ends the process. With the process described above, the sell orders and the buy orders are identified as the contract targets.

FIG. 25 is a diagram (2) illustrating the process of identifying the orders to be the contract targets in the related art. In FIG. 25, in the related art, the information processing apparatus sequentially accepts an order having an order count “2”, an order having an order count “3”, an order having an order count “2”, and an order having an order count “6”, as sell orders.

In the related art, the information processing apparatus sequentially accepts, as buy orders, an order having an order count “5”, an order having an order count “1”, an order having an order count “4”, and an order having an order count “2”.

In the related art, when sequentially accepting the sell orders, the information processing apparatus executes a process on the (sell) array a in a case where the sell order is accepted, thereby setting the (sell) array a to the state as illustrated in FIG. 25. An element of the index i=0, 2 to 11, and 13 of the (sell) array a is ‘T’, and the other elements are “F”. “T” of the index i=0 is set in an initial state.

In the related art, the information processing apparatus sets auxiliary information of a sequence number “1” and a quantity “2” to the index i=2 of the (sell) array a. In the related art, the information processing apparatus sets auxiliary information of a sequence number “2” and a quantity “3” to the index i=3 of the (sell) array a. In the related art, the information processing apparatus sets auxiliary information of a sequence number “3” and a quantity “2” to the index i=4 of the (sell) array a.

In the related art, the information processing apparatus sets auxiliary information of a sequence number “2” and a quantity “3” to the index i=5 of the (sell) array a. In the related art, the information processing apparatus sets auxiliary information of a sequence number “4” and a quantity “6” to the index i=6 of the (sell) array a. In the related art, the information processing apparatus sets auxiliary information of a sequence number “3” and a quantity “2” to the index i=7 of the (sell) array a.

In the related art, the information processing apparatus sets auxiliary information of a sequence number “4” and a quantity “6” to the index i=8 of the (sell) array a. In the related art, the information processing apparatus sets auxiliary information of a sequence number “4” and a quantity “6” to the index i=9 of the (sell) array a. In the related art, the information processing apparatus sets auxiliary information of a sequence number “4” and a quantity “6” to the index i=10 of the (sell) array a.

In the related art, the information processing apparatus sets auxiliary information of a sequence number “4” and a quantity “6” to the index i=11 of the (sell) array a. In the related art, the information processing apparatus sets auxiliary information of a sequence number “4” and a quantity “6” to the index i=13 of the (sell) array a.

In the related art, when sequentially accepting the buy orders, the information processing apparatus executes a process on the (buy) array a in a case where the buy order is accepted, thereby setting the (buy) array a to the state as illustrated in FIG. 25. An element of the index i=0 to 12 of the (buy) array a is ‘T’, and the other elements are “F”. “T” of the index i=0 is set in an initial state.

In the related art, the information processing apparatus sets auxiliary information of a sequence number “2” and a quantity “1” to the index i=1 of the (buy) array a. In the related art, the information processing apparatus sets auxiliary information of a sequence number “4” and a quantity “2” to the index i=2 of the (buy) array a. In the related art, the information processing apparatus sets auxiliary information of a sequence number “4” and a quantity “2” to the index i=3 of the (buy) array a.

In the related art, the information processing apparatus sets auxiliary information of a sequence number “3” and a quantity “4” to the index i=4 of the (buy) array a. In the related art, the information processing apparatus sets auxiliary information of a sequence number “1” and a quantity “5” to the index i=5 of the (buy) array a. In the related art, the information processing apparatus sets auxiliary information of a sequence number “2” and a quantity “1” to the index i=6 of the (buy) array a.

In the related art, the information processing apparatus sets auxiliary information of a sequence number “4” and a quantity “2” to the index i=7 of the (buy) array a. In the related art, the information processing apparatus sets auxiliary information of a sequence number “4” and a quantity “2” to the index i=8 of the (buy) array a. In the related art, the information processing apparatus sets auxiliary information of a sequence number “3” and a quantity “4” to the index i=9 of the (buy) array a.

In the related art, the information processing apparatus sets auxiliary information of a sequence number “3” and a quantity “4” to the index i=10 of the (buy) array a. In the related art, the information processing apparatus sets auxiliary information of a sequence number “4” and a quantity “2” to the index i=11 of the (buy) array a. In the related art, the information processing apparatus sets auxiliary information of a sequence number “4” and a quantity “2” to the index i=12 of the (buy) array a.

In the related art, the information processing apparatus compares the (sell) array a with the (buy) array a, and calculates the largest index among indices in which both an element of the (sell) array a and an element of the (buy) array a are “T”, as a contract count. In the example illustrated in FIG. 25, the largest index among the indices in which both the element of the (sell) array a and the element of the (buy) array a are “T” is the index i=11. For this reason, the information processing apparatus in the related art sets a contract count to “11”.

Based on the “(sell) array a” in FIG. 25, a process in which the information processing apparatus identifies sell orders for a contract in the related art will be described.

The information processing apparatus treats, as a contract target, an order corresponding to the auxiliary information set to the index i=11 corresponding to the contract count “11”. The auxiliary information having the index i=11 corresponds to the order having the sequence number “4” and the quantity “6”. The information processing apparatus acquires the quantity α=6 included in the auxiliary information of the index i=11, and updates the index i=11−6=5.

The information processing apparatus treats an order corresponding to the auxiliary information set to the index i=5 as a contract target. The auxiliary information having the index i=5 corresponds to the order having the sequence number “2” and the quantity “3”. The information processing apparatus acquires the quantity α=3 included in the auxiliary information of the index i=5, and updates the index i=5-3=2.

The information processing apparatus treats an order corresponding to the auxiliary information set to the index i=2 as a contract target. The auxiliary information having the index i=2 corresponds to the order having the sequence number “1” and the quantity “2”. The information processing apparatus acquires the quantity α=2 included in the auxiliary information of the index i=2, and updates the index i=2-2=0. Since the index i=0, the information processing apparatus ends the process.

Based on the “(buy) array a” in FIG. 25, a process in which the information processing apparatus identifies buy orders for a contract in the related art will be described.

The information processing apparatus treats, as a contract target, an order corresponding to the auxiliary information set to the index i=11 corresponding to the contract count “11”. The auxiliary information having the index i=11 corresponds to the order having the sequence number “4” and the quantity “2”. The information processing apparatus acquires the quantity α=2 included in the auxiliary information of the index i=11, and updates the index i=11-2=9.

The information processing apparatus treats an order corresponding to the auxiliary information set to the index i=9 as a contract target. The auxiliary information having the index i=9 corresponds to the order having the sequence number “3” and the quantity “4”. The information processing apparatus acquires the quantity α=4 included in the auxiliary information of the index i=9, and updates the index i=9-4=5.

The information processing apparatus treats an order corresponding to the auxiliary information set to the index i=5 as a contract target. The auxiliary information having the index i=5 corresponds to the order having the sequence number “1” and the quantity “5”. The information processing apparatus acquires the quantity α=5 included in the auxiliary information of the index i=5, and updates the index i=5-5=0. Since the index i=0, the information processing apparatus ends the process.

With the process described above in the related art, the sell orders and the buy orders are identified as the contract targets.

In the same manner as the case where a contract of a total amount is guaranteed, in a case where the minimum contract count is guaranteed, the (sell) array a and the (buy) array a are created, and T is set to an index corresponding to a quantity with which a contract is available.

FIGS. 26 to 29 are diagrams describing a setting process in a case where a minimum contract count is guaranteed in the related art. In FIGS. 26 to 29, description on auxiliary information is omitted. As an example, a case where the information processing apparatus accepts a sell order in which the minimum contract count S=6 and the order count E=7 are set and updates the (sell) array a in the related art will be described. As illustrated in step S120 in FIG. 26, a state of the (sell) array a is a[0]=T, a[3]=T, a[5]=T, and a[8]=T, and other elements are “F”.

Next, step S121 will be described. In the related art, the information processing apparatus sets the index i=0. In the related art, since a[i]=T is satisfied, the information processing apparatus inserts a section [6, 7](=[0+6, 0+7]) into a queue 50.

Next, step 122 will be described. In the related art, the information processing apparatus sets the index i=1. Since a[i]=F is satisfied and i is not included in the head section [6, 7] of the queue 50, no process is executed, for example. In the related art, the information processing apparatus sets the index i=2. Since a[i]=F is satisfied and i is not included in the head section [6, 7] of the queue 50, no process is executed, for example.

Description continues with reference to FIG. 27. Next, step S123 will be described. In the related art, the information processing apparatus sets the index i=3. In the related art, since a[i]=T is satisfied, the information processing apparatus inserts a section [9, 10] (=[3+6, 3+7]) into the queue 50.

Next, step S124 will be described. In the related art, the information processing apparatus sets the index i=4. Since a[i]=F is satisfied and i is not included in the head section [6, 7] of the queue 50, no process is executed, for example.

Next, step S125 will be described. In the related art, the information processing apparatus sets the index i=5. In the related art, since a[i]=T is satisfied, the information processing apparatus inserts a section [11, 12] (=[5+6, 5+7]) into the queue 50. In the related art, the information processing apparatus sets a section [9, 12] obtained by merging the section [9, 10] and the section [11, 12] at an end of the queue 50.

Description continues with reference to FIG. 28. Next, step S126 will be described. In the related art, the information processing apparatus sets the index i=6. Since a[i]=F is satisfied and i is included in the head section [6, 7] of the queue 50, a[i] is set to T.

Next, step S127 will be described. In the related art, the information processing apparatus sets the index i=7. Since a[i]=F is satisfied and i is included in the head section [6, 7] of the queue 50, a[i] is set to T. In the related art, since i is an end of the head section [6, 7], the information processing apparatus deletes the section [6, 7] from the queue 50.

In the related art, for the index i=8 to 14, the information processing apparatus repeatedly executes the process described above. Description of the process of the information processing apparatus when the index i=8 to 14 is set in the related art will be omitted.

Description continues with reference to FIG. 29. Next, step S128 will be described. In the related art, the information processing apparatus sets the index i=15. Since a[i]=F is satisfied and i is included in a head section [14, 15] of the queue 50, a[i] is set to T. In the related art, since i is an end of the head section [14, 15], the information processing apparatus deletes the section [14, 15] from the queue 50.

Next, step S129 will be described. In the related art, since i exceeds i=8 that is the largest index to which T is set, and the queue 50 becomes empty in the (sell) array a, the information processing apparatus ends the process.

With the above description with reference to FIGS. 26 to 29, a case where the information processing apparatus accepts a sell order for which a minimum contract count and an order count are set, and updates the (sell) array a in the related art is described. Also in a case of accepting a buy order for which a minimum contract count and an order count are set and updating the (buy) array a, the information processing apparatus performs the update in the same manner as the process in FIGS. 26 to 29, in the related art.

International Publication Pamphlet No. WO 2020/179072 and Japanese Laid-open Patent Publication No. 2016-129054 are disclosed as related art.

### SUMMARY

According to an aspect of the embodiments, a non-transitory computer-readable recording medium stores a program for causing a computer to execute a process, the process includes setting, based on a sell order count included in information on a sell order, a first array that has elements corresponding to a first section of sell order counts with which a contract is available and a second section of sell order counts with which a contract is unavailable, the information on the sell order being associated with an element corresponding to the first section in the first array, setting, based on a buy order count included in information on a buy order, a second array that has elements corresponding to a third section of buy order counts with which a contract is available and a fourth section of buy order counts with which a contract is unavailable, the information on the buy order being associated with an element corresponding to the third section in the second array, and identifying sell orders and buy orders to be contract targets based on the information set in the first array and the second array.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a first embodiment;

FIG. 2 is a diagram illustrating a reflection method;

FIG. 3 is a diagram illustrating the reflection method on an index;

FIG. 4 is a diagram illustrating an example of the reflection;

FIG. 5 is a block diagram illustrating a functional configuration example of an information processing apparatus according to the first embodiment;

FIG. 6 is a diagram illustrating an example of a data structure of a sell order table according to the first embodiment;

FIG. 7 is a diagram illustrating an example of a data structure of a buy order table according to the first embodiment;

FIG. 8 is a diagram illustrating an example of a data structure of first array information according to the first embodiment;

FIG. 9 is a diagram illustrating an example of a data structure of second array information according to the first embodiment;

FIG. 10 is a flowchart illustrating an operation example of the information processing apparatus according to the first embodiment;

FIG. 11 is a diagram illustrating a second embodiment in which a price is taken into consideration;

FIG. 12 is a diagram illustrating an example of a data structure of a sell order table according to the second embodiment;

FIG. 13 is a diagram illustrating an example of a data structure of a buy order table according to the second embodiment;

FIG. 14 is a diagram illustrating an example of a data structure of first array information according to the second embodiment;

FIG. 15 is a diagram illustrating an example of a data structure of second array information according to the second embodiment;

FIG. 16 is a flowchart illustrating an operation example of an information processing apparatus according to the second embodiment;

FIG. 17 is a flowchart illustrating an operation example of the information processing apparatus according to the second embodiment;

FIG. 18 is a diagram illustrating compression of indices;

FIG. 19 is a diagram illustrating an example of a hardware configuration of a computer that implements a function in the same manner as a function of the information processing apparatus according to the embodiment;

FIG. 20 is a diagram (1) illustrating a process on an array in a case where a sell order is accepted in the related art;

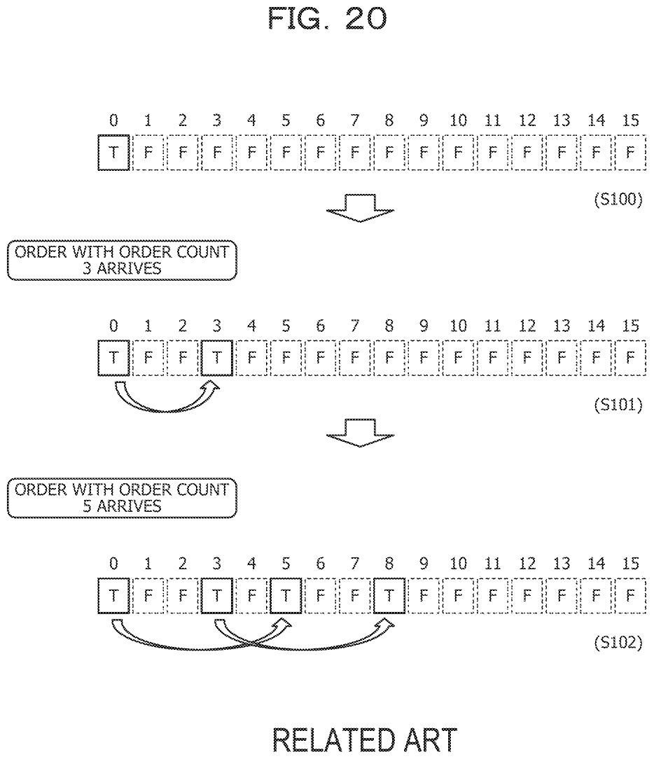

FIG. 21 is a diagram illustrating an example of an array in a case where a buy order is accepted in the related art;

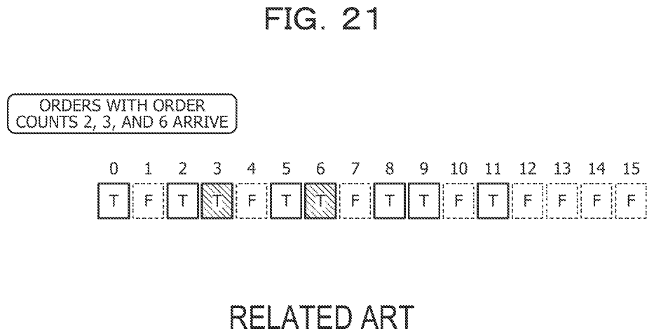

FIG. 22 is a diagram illustrating an example of a process of calculating a contract count in the related art;

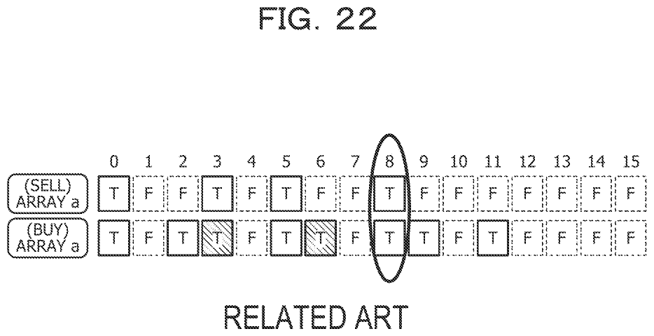

FIG. 23 is a diagram (2) illustrating the process on the array in the case where the sell order is accepted in the related art;

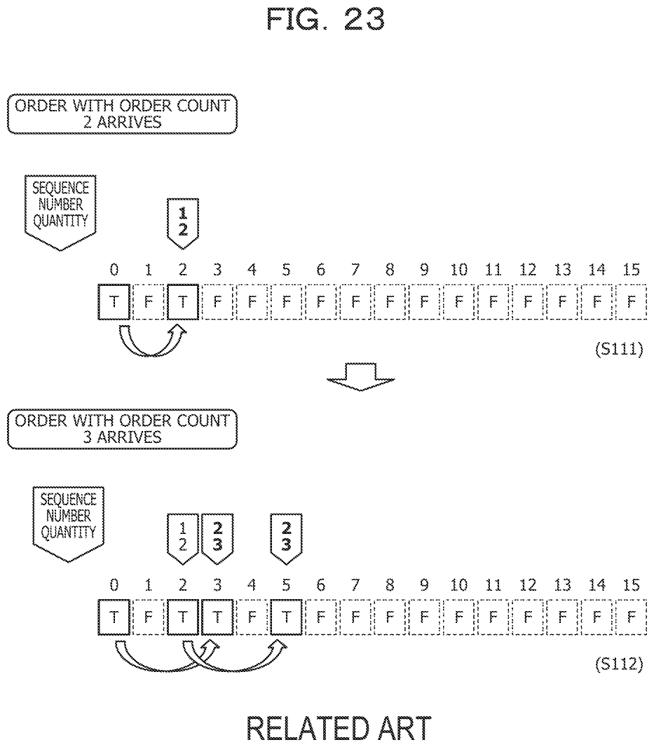

FIG. 24 is a diagram (1) illustrating a process of identifying orders to be contract targets in the related art;

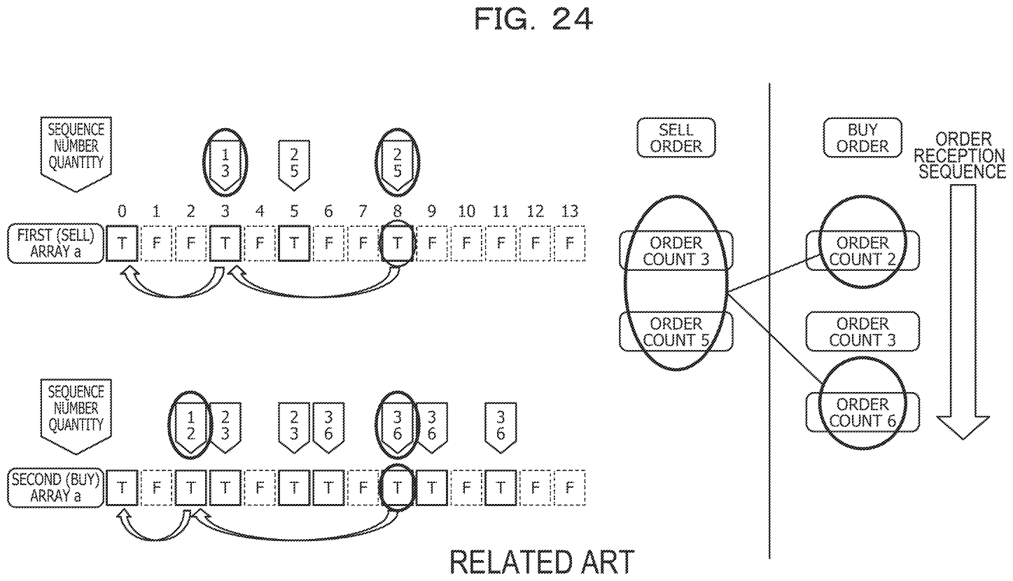

FIG. 25 is a diagram (2) illustrating a process of identifying orders to be contract targets in the related art;

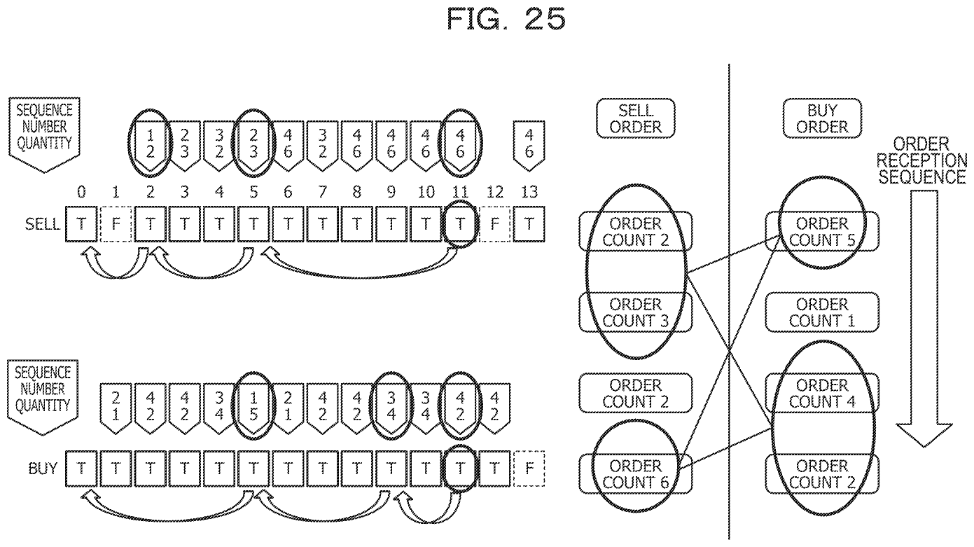

FIG. 26 is a diagram (1) illustrating a setting process in a case where a minimum contract count is guaranteed in the related art;

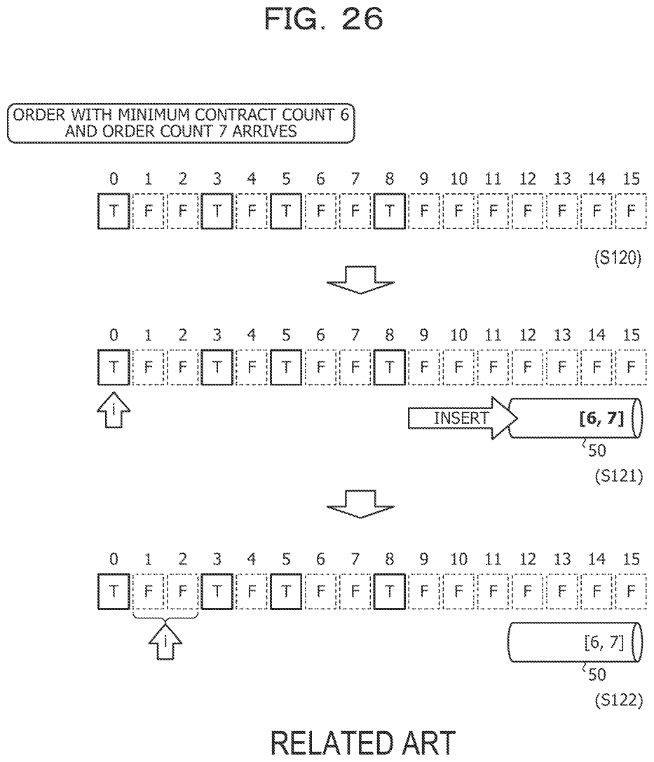

FIG. 27 is a diagram (2) illustrating the setting process in the case where the minimum contract count is guaranteed in the related art;

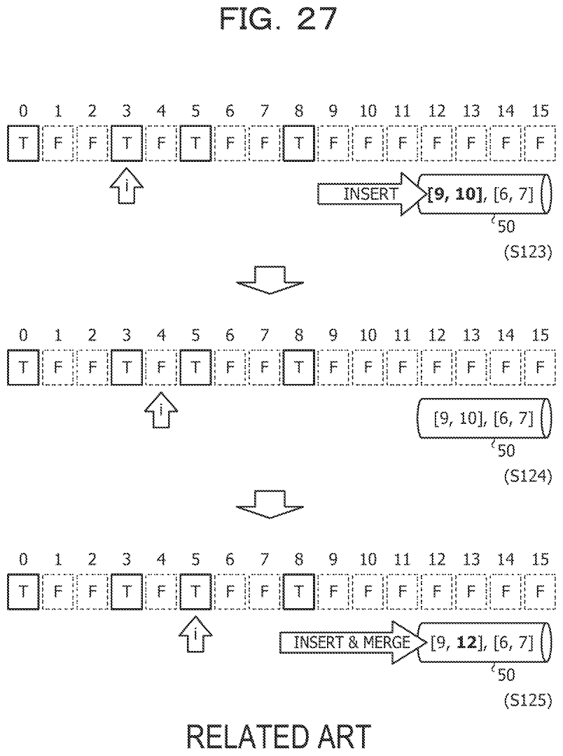

FIG. 28 is a diagram (3) illustrating the setting process in the case where the minimum contract count is guaranteed in the related art; and

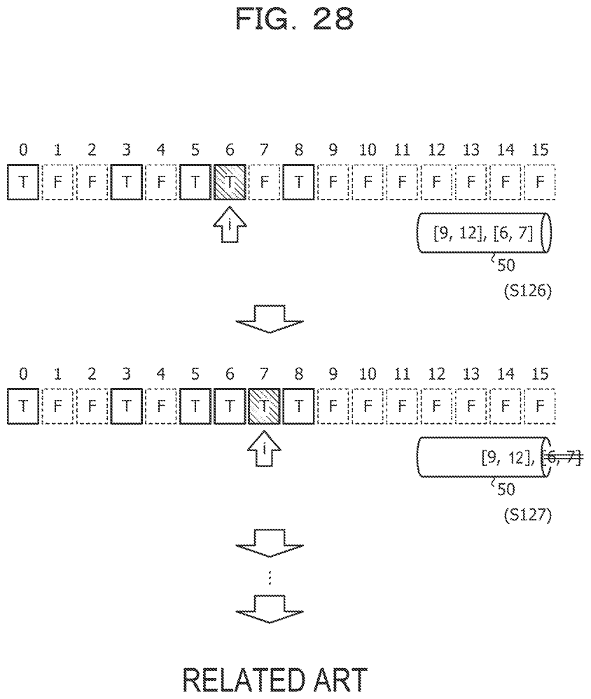

FIG. 29 is a diagram (4) illustrating the setting process in the case where the minimum contract count is guaranteed in the related art.

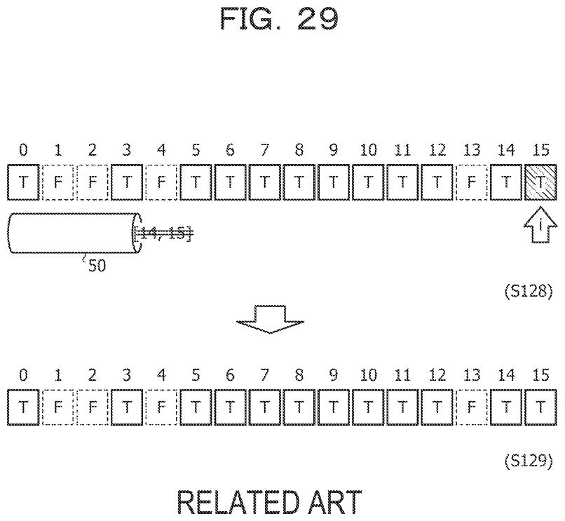

### DESCRIPTION OF EMBODIMENTS

In the related art described above, since each index is handled as one element, in an array related to sell orders and buy orders, even in a section in which T is continuous or a section in which F is continuous, each index is handled as each element. For this reason, in the related art, when performing a process of adding in sections on the array related to the sell order and the buy order, each element is added one by one, so that there is a problem that calculation cost increases in terms of time and memory.

Hereinafter, a contract method and an information processing apparatus according to embodiments will be described below with reference to the drawings. In the embodiments, configurations having the same functions are denoted by the same reference sign, and redundant description thereof is omitted. The contract method and the information processing apparatus to be described in the embodiments below are merely examples, and are not intended to limit the embodiments. The individual embodiments below may be appropriately combined with each other within a scope without any contradiction.

### First Embodiment

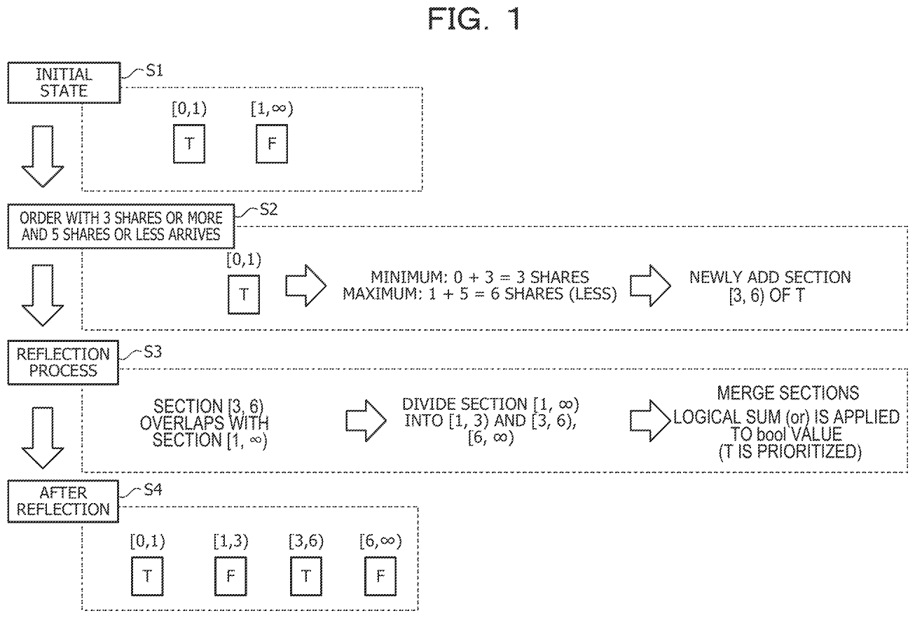

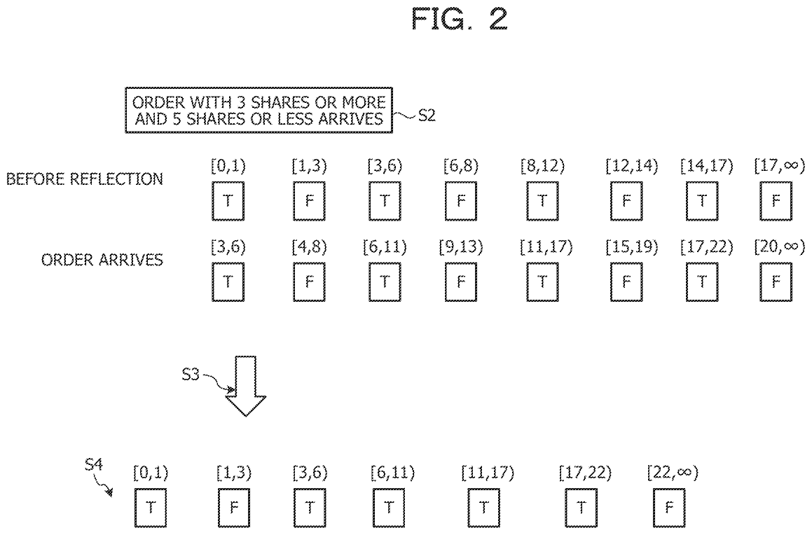

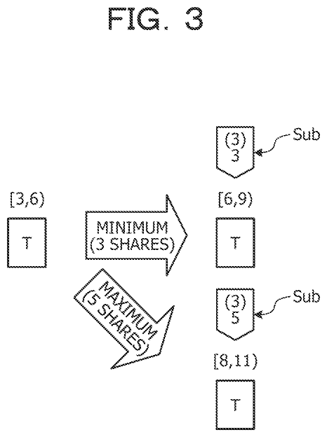

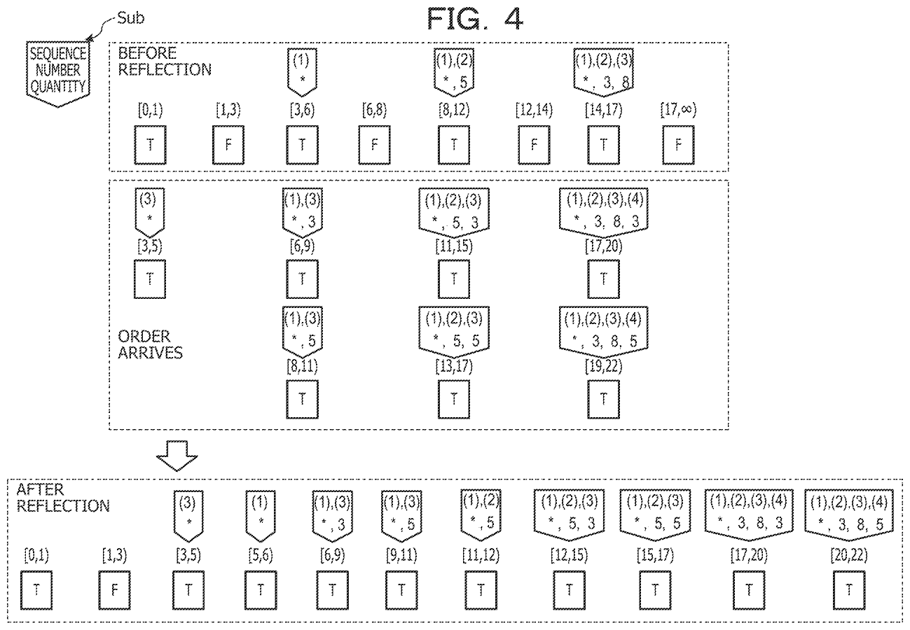

First, a first embodiment will be described with reference to FIGS. 1 to 4. FIG. 1 is a diagram illustrating the first embodiment. FIG. 2 is a diagram illustrating a reflection method. FIG. 3 is a diagram illustrating the reflection method on an index. FIG. 4 is a diagram illustrating an example of the reflection.

As illustrated in FIG. 1, in an information processing apparatus according to the first embodiment, for a Bool (T, F) array for managing each of sell orders and buy orders, each order count is not managed as an index (element), but a section of order counts with which a contract is available (T) and a section of order counts with which a contract is unavailable (F) are managed as elements. Therefore, with the information processing apparatus according to the first embodiment, it is possible to significantly reduce the number of elements for an array, and to reduce calculation costs such as the amount of memory desired for the array and the number of operations in matching of sell orders and buy orders.

For example, for sell orders, the information processing apparatus according to the first embodiment sets an array (hereafter, referred to as a first array) in which a section of sell order counts with which a contract is available (T) and a section of sell order counts with which a contract is unavailable (F) are set as elements, and information on the sell orders such as an order sequence or a price is associated with the element of the section related to T as auxiliary information.

For buy orders, the information processing apparatus according to the first embodiment sets an array (hereafter, referred to as a second array) in which a section of buy order counts with which a contract is available (T) and a section of buy order counts with which a contract is unavailable (F) are set as elements, and information on the buy orders such as an order sequence or a price is associated with the element of the section related to T as auxiliary information.

In the following description, when the first array and the second array are not distinguished from each other, the first array and the second array are simply referred to as an “array”.

The information processing apparatus according to the first embodiment handles the section of order counts with which a contract is available (T) and the section of order counts with which a contract is unavailable (F) as half-open sections in which one common direction with each other (upper limit side (right direction) or lower limit side (left direction)) is set as a closed section. A case of a half-open section [1, r) is a set of integers x satisfying I≤x<r, and is a half-open section in which the left direction is closed. By using such a half-open section, the information processing apparatus according to the first embodiment may seamlessly handle a half-open section (for example, [0, 1)) of order counts with which a contract is available (T) and a half-open section (for example, [1, ∞)) of order counts with which a contract is unavailable (F).

First, it is assumed that the information processing apparatus according to the first embodiment sets an initial state of an array illustrated in step S1. At the initial state of the array, a half-open section [0, 1) of order counts with which a contract is available (T) corresponding to the order count of 0 and a half-open section [1, ∞) of order counts with which a contract is unavailable (F) are set as elements (indices).

Next, in step S2, it is assumed that an order for requesting a contract with 3 shares or more and 5 shares or less arrives, and the information processing apparatus according to the first embodiment accepts the order. In this manner, in a case where a new order is accepted, the information processing apparatus according to the first embodiment updates the array based on contents of the new order, and reflects the new order in the array.

For example, the information processing apparatus according to the first embodiment evaluates a section to which each section of order counts with which a contract is available (T) included in the array is to be shifted, under a condition of an order count included in the new order.

For example, the information processing apparatus according to the first embodiment obtains a section to which the half-open section [0, 1) of order counts with which a contract is available (T) included in the array is to be shifted by the order with 3 shares or more and 5 shares or less. In this case, the left side (minimum) of the half-open section [0, 1) is 0+3=3 shares, and the right side (maximum) is 1+5=6 shares (less than). Therefore, the half-open section [0, 1) is shifted to [3, 6). The half-open section [3, 6) after the shifting by the new order is a section that is newly added to the array as a section of order counts with which a contract is available (T).

Next, in step S3, the information processing apparatus according to the first embodiment integrates the half-open section [3, 6) after the shifting into the array, and executes a reflection process of reflecting contents of the new order in the array. Therefore, in step S4, the array after the reflection process is obtained.

For example, the information processing apparatus according to the first embodiment compares the half-open section [3, 6) of the available contract (T) after the shifting with the half-open section ([1, ∞) in FIG. 1) of the unavailable contract (F) already in the array to divide the overlapping half-open section of the unavailable contract. For example, the half-open section [1, ∞) of the unavailable contract (F) is divided into [1, 3), [3, 6), and [6, ∞). Next, the information processing apparatus according to the first embodiment sequentially selects a section having a smaller starting point and merges the common portions. By this merging, as for the bool value (T) representing that a contract is available, T is prioritized by a logical sum (or).

As illustrated in FIG. 2, for example, the information processing apparatus according to the first embodiment sorts the sections of the array before reflection and the sections shifted by arrival of the new order, in ascending order of starting points of the sections. Next, the information processing apparatus according to the first embodiment sequentially selects a section having a smaller starting point between heads of both the sections before reflection and the sections shifted by the arrival, and merges the common portions of the sections. For example, in a case of the example in FIG. 2, the information processing apparatus according to the first embodiment merges [3, 6), [6, 11), [11, 17), and [17, 22) in which the half-open section of order counts with which a contract is available (T) continues, and sets a half-open section [3, 22) of order counts with which a contract is available (T).

Next, the information processing apparatus according to the first embodiment registers (reflects) auxiliary information including an order reception sequence (order sequence) and a quantity (order count) in the half-open section (index) of order counts with which a contract is available (T), which is newly added by the reflection process. By referring to the auxiliary information registered in the half-open section of order counts with which a contract is available (T) and following the order reception sequence (order sequence) and the quantity (order count) included in the auxiliary information, the information processing apparatus according to the first embodiment may identify orders to be contract targets.

For example, as illustrated in FIG. 3, the information processing apparatus according to the first embodiment registers auxiliary information Sub including an order sequence (a numerical value in parentheses in the upper part) and an order count (a numerical value in the lower part) in each of the half-open sections [6, 9) and [8, 11) shifted from the half-open section [3, 6) of order counts with which a contract is available (T). The example in FIG. 3 describes a case where the order has the order count of 3 shares or more and 5 shares or less, and the auxiliary information Sub indicating an order count of 3 shares is registered for the half-open section [6, 9) shifted in accordance with the minimum 3 shares. The auxiliary information Sub indicating an order count of 5 shares is registered for the half-open section [8, 11) shifted in accordance with the maximum 5 shares.

In a case where the auxiliary information Sub is already registered in the half-open section before the shifting, the information processing apparatus according to the first embodiment performs registration (reflection) in a form of adding the order reception sequence (order sequence) and the quantity (order count) of this time to the auxiliary information Sub. For example, as illustrated in FIG. 4, the information processing apparatus according to the first embodiment adds an order reception sequence “(3)” and a quantity “3” of this time to the existing auxiliary information Sub including the order reception sequence “(1)” and the quantity “* (* represents all remaining shares)”, for the half-open section [6, 9) shifted by the half-open section [3, 6) of order counts with which a contract is available (T).

The information processing apparatus according to the first embodiment identifies orders to be contract targets by following the order reception sequence (order sequence) and the quantity (order count) included in the auxiliary information Sub of the half-open section identified by matching. For example, it is assumed that the information processing apparatus according to the first embodiment identifies a contract with 12 shares in the half-open section [11, 12) of order counts with which a contract is available (T) by matching. In this case, with the order reception sequence “(1), (2)” and the order count “*, 5” included in the auxiliary information Sub of the half-open section [11, 12), the information processing apparatus according to the first embodiment may identify a contract of 5 shares in the second order and a contract of all remaining shares (12-5=7 shares) in the first order.

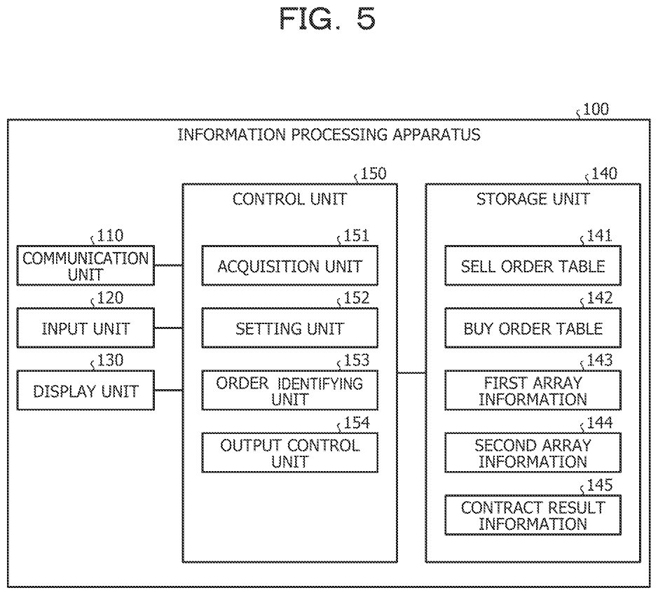

An example of a configuration of the information processing apparatus according to the first embodiment that executes the process described with reference to FIGS. 1 to 4 will be described. FIG. 5 is a block diagram illustrating an example of a functional configuration of the information processing apparatus according to the first embodiment. As illustrated in FIG. 5, an information processing apparatus 100 includes a communication unit 110, an input unit 120, a display unit 130, a storage unit 140, and a control unit 150.

The communication unit 110 is coupled to an external apparatus or the like in a wired or wireless manner, and transmits and receives information to and from the external apparatus or the like. The communication unit 110 is implemented by, for example, a network interface card (NIC) or the like. The communication unit 110 may be coupled to a network (not illustrated). For example, the communication unit 110 receives information regarding a sell order table 141 that includes information on sell orders, information regarding a buy order table 142 that includes information on buy orders, and the like from the external apparatus. For example, the external apparatus corresponds to a server that manages buying and selling of shares, and executes various types of processes related to orders as contract targets.

The input unit 120 is an input device that inputs various types of information to the information processing apparatus 100. The input unit 120 corresponds to a keyboard, a mouse, a touch panel, or the like.

The display unit 130 is a display device that displays information output from the control unit 150. The display unit 130 corresponds to a liquid crystal display, an organic electroluminescence (EL) display, a touch panel, or the like.

The storage unit 140 includes the sell order table 141, the buy order table 142, first array information 143, second array information 144, and contract result information 145. For example, the storage unit 140 is implemented by a semiconductor memory element such as a random-access memory (RAM) or a flash memory, or a storage device such as a hard disk or an optical disc.

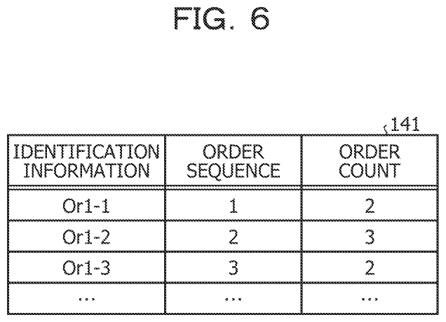

The sell order table 141 is a table in which information on a sell order, such as an order sequence and an order count of the sell order is held. FIG. 6 is a diagram illustrating an example of a data structure of the sell order table 141 according to the first embodiment. As illustrated in FIG. 6, in the sell order table 141, identification information, an order sequence, and an order count are associated with each other. The identification information is information for uniquely identifying an order. The order sequence is a sequence number of the accepted order. The order count is an order count of the order.

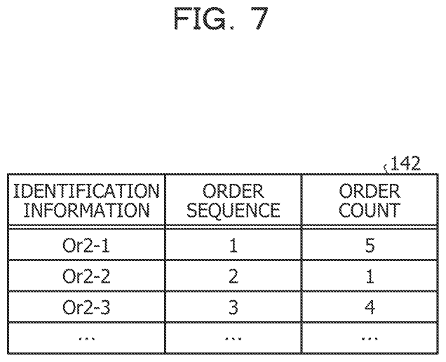

The buy order table 142 is a table in which information on a buy order, such as an order sequence and an order count of the buy order is held. FIG. 7 is a diagram illustrating an example of a data structure of the buy order table 142 according to the first embodiment. As illustrated in FIG. 7, in the buy order table 142, identification information, an order sequence, and an order count are associated with each other. The identification information is information for uniquely identifying an order. The order sequence is a sequence number of the accepted order. The order count is an order count of the order.

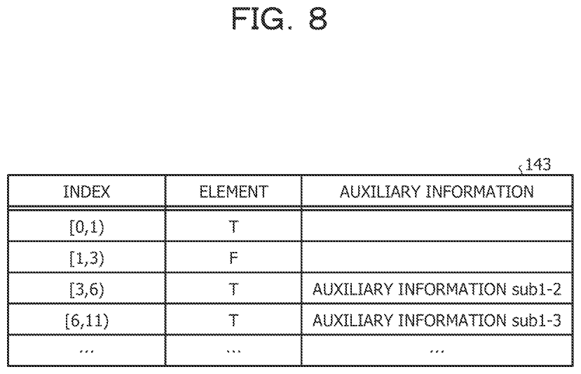

The first array information 143 is array information for holding information based on an order sequence and an order count related to a sell order. The first array information 143 corresponds to the first array described above. FIG. 8 is a diagram illustrating an example of a data structure of the first array information 143 according to the first embodiment. As illustrated in FIG. 8, the first array information 143 includes an index, an element, and auxiliary information. The index corresponds to each section of the first array. The element is an element of the first array, and “T” or “F” is set in the element. The auxiliary information is information on a sell order with which a contract is available, including an order reception sequence (order sequence), a quantity (order count), and the like.

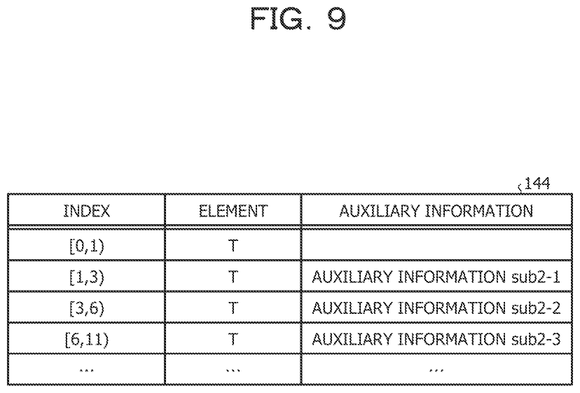

The second array information 144 is array information for holding information based on an order sequence and an order count related to a buy order. The second array information 144 corresponds to the second array described above. FIG. 9 is a diagram illustrating an example of a data structure of the second array information 144 according to the first embodiment. As illustrated in FIG. 9, the second array information 144 includes an index, an element, and auxiliary information. The index corresponds to each section of the second array. The element is an element of the second array, and “T” or “F” is set in the element. The auxiliary information is information on a buy order with which a contract is available, including an order reception sequence (order sequence), a quantity (order count), and the like.

The contract result information 145 holds a maximum contract count and information on orders as contract targets. For example, the contract result information 145 includes contract sell identification information, contract buy identification information, and a maximum contract count. The contract sell identification information is information for identifying a sell order to be a contract target. The contract buy identification information is information for identifying a buy order to be a contract target. The maximum contract count indicates a contract count having the maximum count.

Returning to the description in FIG. 5. The control unit 150 includes an acquisition unit 151, a setting unit 152, an order identifying unit 153, and an output control unit 154. For example, the control unit 150 is implemented by a central processing unit (CPU) or a microprocessor unit (MPU). The control unit 150 may also be implemented by an integrated circuit such as an application-specific integrated circuit (ASIC) or a field-programmable gate array (FPGA), for example.

In a case of acquiring data of the sell order table 141 from an external apparatus or the like, the acquisition unit 151 stores the data of the sell order table 141 in the storage unit 140. The acquisition unit 151 may acquire sell orders individually and sequentially, and register information on the acquired sell orders in the sell order table 141.

In a case of acquiring data of the buy order table 142 from the external apparatus or the like, the acquisition unit 151 stores the data of the buy order table 142 in the storage unit 140. The acquisition unit 151 may acquire buy orders individually and sequentially, and register information on the acquired buy orders in the buy order table 142.

With reference to the sell order table 141, the setting unit 152 sets information based on an order sequence and an order count related to a sell order in the first array information 143 (first array). With reference to the buy order table 142, the setting unit 152 sets information based on an order sequence and an order count related to a buy order in the second array information 144 (second array).

The process in which the setting unit 152 sets the information based on the order sequence and the order count related to the sell order in the first array information 143 with reference to the sell order table 141 corresponds to the process of the array described with reference to FIGS. 1 to 4.

For example, for the first array information 143, in step S1, the setting unit 152 sets, as elements (indices), the half-open section [0, 1) of order counts with which a contract is available (T) corresponding to the order count of 0 and the half-open section [1, ∞) of order counts with which a contract is unavailable (F). Next, the setting unit 152 repeatedly executes the processes in steps S2 to S4, for each sell order in the sell order table 141. The setting unit 152 registers (reflects) the auxiliary information Sub including an order reception sequence (order sequence) and a quantity (order count) in the half-open section (index) of order counts with which a contract is available (T), which is newly added by the reflection process.

In the same manner, the process in which the setting unit 152 sets the information based on the order sequence and the order count related to the buy order in the second array information 144 with reference to the buy order table 142 corresponds to the process of the array described with reference to FIGS. 1 to 4.

For example, for the second array information 144, in step S1, the setting unit 152 sets, as elements (indices), the half-open section [0, 1) of order counts with which a contract is available (T) corresponding to the order count of 0 and the half-open section [1, ∞) of order counts with which a contract is unavailable (F). Next, the setting unit 152 repeatedly executes the processes in steps S2 to S4, for each buy order in the buy order table 142. The setting unit 152 registers (reflects) the auxiliary information Sub including an order reception sequence (order sequence) and a quantity (order count) in the half-open section (index) of order counts with which a contract is available (T), which is newly added by the reflection process.

The order identifying unit 153 is a processing unit that identifies orders to be contract targets, based on the first array information 143 and the second array information 144. For example, the order identifying unit 153 obtains overlapping sections by matching the half-open sections of the sell order count with which a contract is available (T) included in the first array information 143 and the half-open sections of the buy order count with which a contract is available (T) included in the second array information 144. Next, based on the maximum value in the obtained overlapping sections, the output control unit 154 identifies sell orders and buy orders with the maximum contract count.

Next, the order identifying unit 153 sequentially identifies orders to be contract targets by following the order reception sequence (order sequence) and the quantity (order count) included in the auxiliary information Sub of the identified half-open section as described above. Next, the order identifying unit 153 registers the identification information of the order identified as the contract target by executing the process described above, in the contract result information 145.

The output control unit 154 is a processing unit that outputs the contract result information 145 to the display unit 130 so as to display the contract result information 145. The output control unit 154 may transmit the contract result information 145 to an external apparatus, and request various contract processes to the external apparatus.

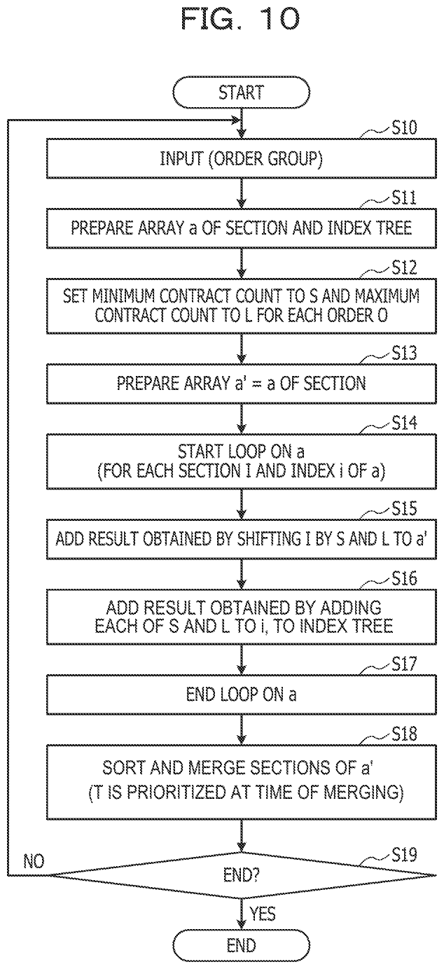

Next, an example of a processing procedure of the information processing apparatus 100 according to the first embodiment will be described. FIG. 10 is a flowchart illustrating the operation example of an information processing apparatus 100 according to the first embodiment, and illustrates a process related to setting of first array information 143 and second array information 144 performed by the setting unit 152, for example.

As illustrated in FIG. 10, when a process is started, the setting unit 152 accepts an input of an order group (step S10). The order group includes the first array information 143 in a case of a sell order and includes the second array information 144 in a case of a buy order. Since both the sell order and the buy order are processed in the same manner in the first embodiment, these orders will be simply referred to as an “order” in the following description.

Next, the setting unit 152 prepares an array a and an index tree (for example, a trie) for managing a section of order counts with which a contract is available (T) and a section of order counts with which a contract is unavailable (F) (step S11).

Next, for each order 0 Included in the order group, the setting unit 152 sets a minimum contract count to S and sets a maximum contract count to L (step S12). For example, in a case where the order 0 is an order for requesting a contract of 3 shares or more and 5 shares or less, S is 3 and L is 5.

Next, the setting unit 152 prepares an array a′=a of sections (step S13), and executes a loop process on the array a (step S14 to step S17). In the loop process on the array a, the processes in steps S15 and S16 are repeated for each section I (the section of order counts with which a contract is available (T) and the section of order counts with which a contract is unavailable (F)) included in the array a and each index i.

For example, the setting unit 152 shifts each section I by the minimum contract count S and the maximum contract count L, and adds the result to the array a′ (step S15). Next, the setting unit 152 adds each of S and L to the index i, and adds the result to the index tree (step S16). By this loop process, the setting unit 152 generates the array a′ illustrated in the middle part in FIG. 4.

After the loop process (step S14 to step S17) on the array a, the setting unit 152 sorts and merges the sections of the array a′ (step S18). At this step S18, the setting unit 152 gives a priority to a section having an element of T (contract is available) as an overlapping portion (section) at a time of merging.

Next, the setting unit 152 makes an end determination such as whether or not all orders of the order group is processed (step S19), and ends the process in a case where the determination result is positive (Yes in S19). In a case where the determination result is negative (No in S19), the setting unit 152 returns the process to S10.

### Second Embodiment

According to the first embodiment described above, whether or not a contract is available (T/F value) is managed based on the order quantity (share quantity) included as an order condition, and a price (price to sell/price to buy) is not taken into consideration. A case where a price is also taken into consideration will be described in a second embodiment.

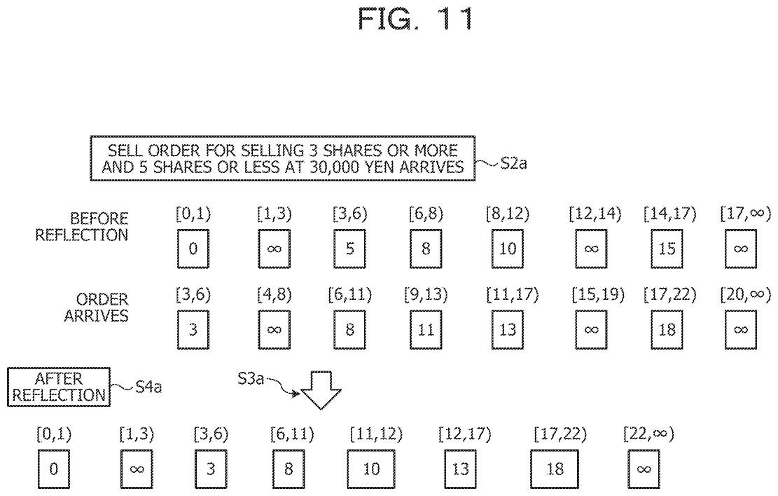

FIG. 11 is a diagram illustrating the second embodiment in which a price is taken into consideration. As illustrated in FIG. 11, in the information processing apparatus 100 according to the second embodiment in a case where a price is taken into consideration, instead of a T/F value, the price with which a contract is available for buying and selling is managed by an array with each section.

For example, instead of the T/F value, a minimum price for contract in each section is managed in a first array related to the sell order. A maximum price for contract in each section is managed in a second array related to the buy order, instead of the T/F value. A value such as “co” may be substituted in a case where a contract is unavailable (F).

In the same manner as the first embodiment, in a case where a new order for selling 3 shares or more and 5 shares or less at 30,000 yen arrives (step S2a), the information processing apparatus 100 according to the second embodiment updates the array based on the contents of the new order (step S3a), and reflects the new order in the array (step S4a). By the merging here, a low price in the first array related to the sell order and a high price in the second array related to the buy order are prioritized.

For example, in a case of the example in FIG. 11 (first array related to the sell order), when merging a half-open section [3, 6), the information processing apparatus 100 according to the second embodiment gives a priority to “3” having a lower price, of “5” before reflection and “3” after the order arrival (after reflection).

By matching the first array and the second array including such a price, the order identifying unit 153 in the information processing apparatus 100 according to the second embodiment may identify orders to be contract targets in consideration of the price. For example, the order identifying unit 153 in the information processing apparatus 100 according to the second embodiment identifies orders of maximum quantities having the same price, and sequentially identifies the orders to be contract targets by following an order reception sequence (order sequence) and a quantity (order count) included in the auxiliary information Sub in the identified half-open section.

The information processing apparatus 100 according to the second embodiment has a configuration different from the configuration corresponding to the sell order table 141, the buy order table 142, the first array information 143, and the second array information 144 in the first embodiment, and the other configurations have the same manner as the first embodiment.

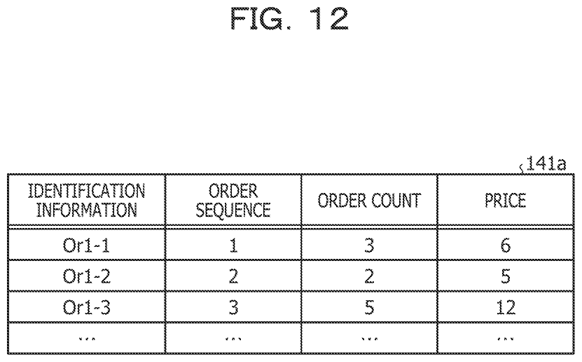

FIG. 12 is a diagram illustrating an example of a data structure of a sell order table according to the second embodiment. As illustrated in FIG. 12, in a sell order table 141a, identification information, an order sequence, an order count, and a price are associated with each other. The identification information is information for uniquely identifying an order. The order sequence is a sequence number of the accepted order. The order count is an order count of the order. The price is a desired price for selling.

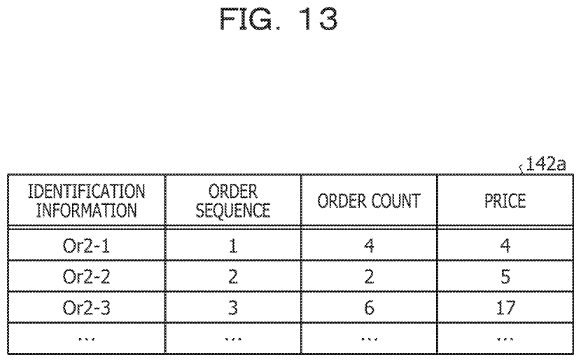

FIG. 13 is a diagram illustrating an example of a data structure of a buy order table 142a according to the second embodiment. As illustrated in FIG. 13, in the buy order table 142a, identification information, an order sequence, an order count, and a price are associated with each other. The identification information is information for uniquely identifying an order. The order sequence is a sequence number of the accepted order. The order count is an order count of the order. The price is a desired price for buying.

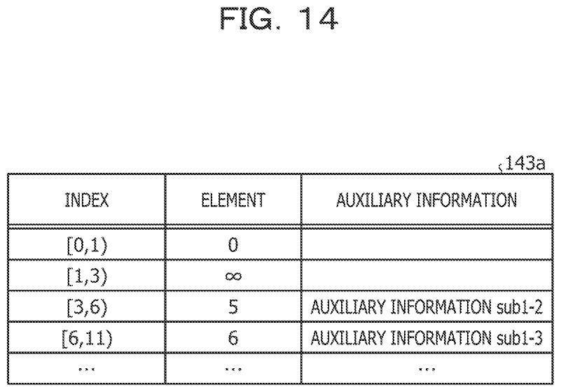

FIG. 14 is a diagram illustrating an example of a data structure of first array information according to the second embodiment. As illustrated in FIG. 14, first array information 143a includes an index, an element, and auxiliary information. The index corresponds to each section of the first array. The element is an element of the first array, and a minimum price for contract is set instead of ‘T’ indicating that the contract is available, “co” is set instead of “F” indicating that the contract is unavailable, and the like. The auxiliary information is information on a sell order with which a contract is available, including an order reception sequence (order sequence), a quantity (order count), and the like.

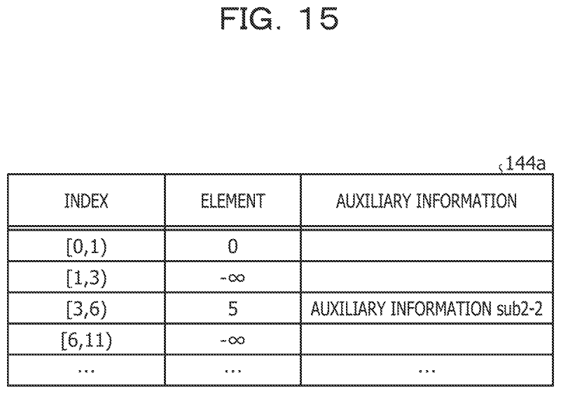

FIG. 15 is a diagram illustrating an example of a data structure of second array information according to the second embodiment. As illustrated in FIG. 15, second array information 144a includes an index, an element, and auxiliary information. The index corresponds to each section of the second array. The element is an element of the second array, and a maximum price for contract is set instead of “T” indicating that the contract is available, “−0” is set instead of “F” indicating that the contract is unavailable, and the like. The auxiliary information is information on a buy order with which a contract is available, including an order reception sequence (order sequence), a quantity (order count), and the like.

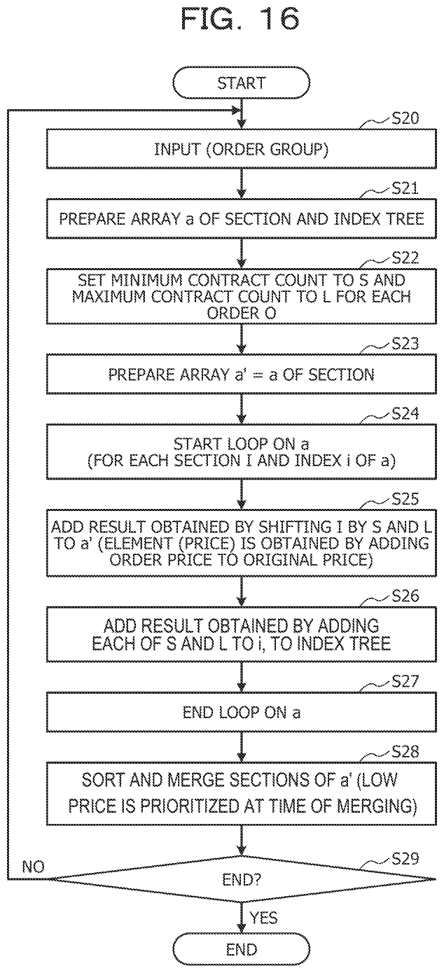

Next, an example of a processing procedure of the information processing apparatus 100 according to the second embodiment will be described. FIG. 16 is a flowchart illustrating an operation example of the information processing apparatus 100 according to the second embodiment, and illustrates a process related to setting of first array information 143a performed by the setting unit 152, for example.

As illustrated in FIG. 16, when a process is started, the setting unit 152 accepts an input of an order group (step S20). The order group includes sell orders included in the first array information 143a.

Next, the setting unit 152 prepares an array a and an index tree (for example, a trie) for managing a section of order counts with which a contract is available (prices is set) and a section of order counts with which a contract is unavailable (∞) (step S21).

Next, for each sell order O included in the order group, the setting unit 152 sets a minimum contract count to S and sets a maximum contract count to L (step S22). For example, in a case where the sell order O is an order for requesting a contract of 3 shares or more and 5 shares or less, S is 3 and L is 5.

Next, the setting unit 152 prepares the array a′=a of sections (step S23), and executes a loop process on the array a (step S24 to step S27). In the loop process on the array a, the processes in steps S25 and S26 are repeated for each section I (the section of order counts with which a contract is available (price is set) and the section of order counts with which a contract is unavailable (∞)) and each index i included in the array a.

For example, the setting unit 152 shifts each section I by the minimum contract count S and the maximum contract count L, and adds the result to the array a′ (step S25). Next, the setting unit 152 adds each of S and L to the index i, and adds the result to the index tree (step S26). It is assumed that an element (price) is obtained by adding the order price of the sell order O to the original price already set in the section. By this loop process, the setting unit 152 generates the array a′ illustrated in the middle part in FIG. 11.

After the loop process (step S24 to step S27) on the array a, the setting unit 152 sorts and merges the sections of the array a′ (step S28). At this step S28, the setting unit 152 gives a priority to a section having a low element (price) as an overlapping portion (section) at a time of merging.

Next, the setting unit 152 makes an end determination such as whether or not all orders of the order group is processed (step S29), and ends the process in a case where the determination result is positive (Yes in S29). In a case where the determination result is negative (No in S29), the setting unit 152 returns the process to 520.

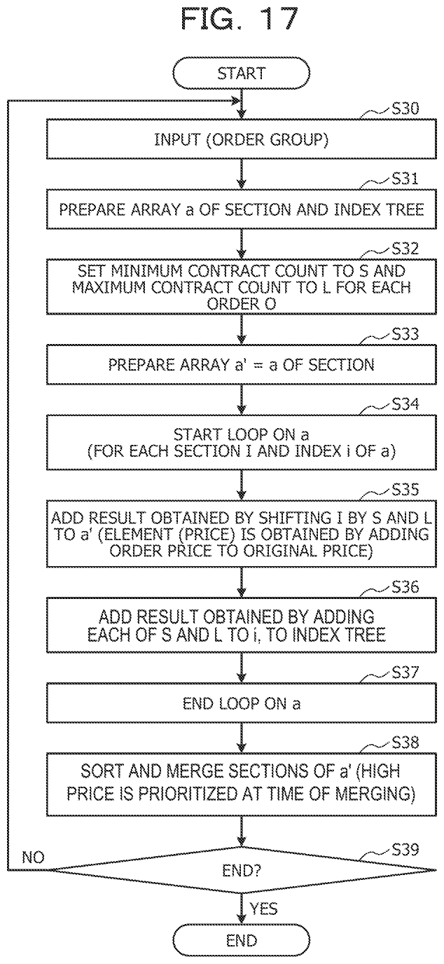

FIG. 17 is a flowchart illustrating an operation example of the information processing apparatus 100 according to the second embodiment, and illustrates a process related to setting of the second array information 144a performed by the setting unit 152, for example.

As illustrated in FIG. 17, when a process is started, the setting unit 152 accepts an input of an order group (step S30). The order group includes buy orders included in the second array information 144a.

Next, the setting unit 152 prepares an array a and an index tree (for example, a trie) for managing a section of order counts with which a contract is available (prices is set) and a section of order counts with which a contract is unavailable (−∞) (step S31).

Next, for each buy order 0 included in the order group, the setting unit 152 sets a minimum contract count to S and sets a maximum contract count to L (step S32). For example, in a case where the buy order 0 is an order for requesting a contract of 3 shares or more and 5 shares or less, S is 3 and L is 5.

Next, the setting unit 152 prepares the array a′=a of sections (step S33), and executes a loop process on the array a (step S34 to step S37). In the loop process on the array a, the processes in steps S35 and S36 are repeated for each section I included in the array a (the section of order counts with which a contract is available (prices is set) and the section of order counts with which a contract is unavailable (−∞)) and each index i.

For example, the setting unit 152 shifts each section I by the minimum contract count S and the maximum contract count L, and adds the result to the array a′ (step S35). Next, the setting unit 152 adds each of S and L of the last order to the index i, and adds the result to the array a′ (step S36). It is assumed that an element (price) is obtained by adding the order price of the buy order O to the original price already set in the section.

After the loop process (step S34 to step S37) on the array a, the setting unit 152 sorts and merges the sections of the array a′ (step S38). At this step S38, the setting unit 152 gives a priority to a section having a high element (price) as an overlapping portion (section) at a time of merging.

Next, the setting unit 152 makes an end determination such as whether or not all orders of the order group is processed (step S39), and ends the process in a case where the determination result is positive (Yes in 539). In a case where the determination result is negative (No in S39), the setting unit 152 returns the process to 530.

When the index (order sequence) in the first embodiment and the second embodiment described above is managed by using a trie, information may be compressed and efficient search (for example, tracing the order sequence and the like) may be performed.

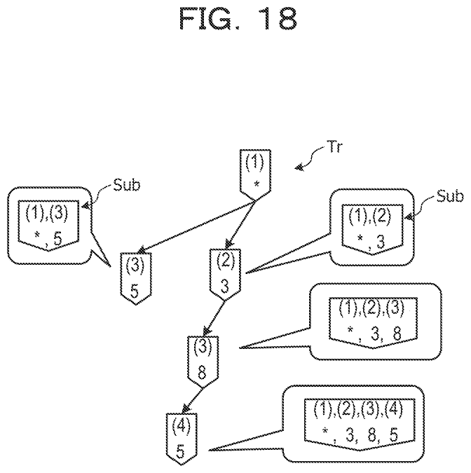

FIG. 18 is a diagram illustrating compression of indices. As illustrated in FIG. 18, memory efficiency is low when all indices are stored. Meanwhile, the index has a property of being added to the previous one, so that duplication may be avoided by using a structure of a trie Tr and referring to a pointer of a node of the tree. In a case where the index (order sequence) is managed by the trie Tr, the order with which a contract is to be made may be easily identified by tracing the trie Tr in the opposite direction (from bottom to top).

As described above, based on a sell order count included in information on a sell order, the information processing apparatus 100 sets a first section of sell order counts with which a contract is available and a second section of sell order counts with which a contract is unavailable as elements, and sets a first array in which the information on the sell order is associated with the element of the first section. Based on a buy order count included in information on a buy order, the information processing apparatus 100 sets a third section of buy order counts with which a contract is available and a fourth section of buy order counts with which a contract is unavailable as elements, and sets a second array in which the information on the buy order is associated with the element of the third section. The information processing apparatus 100 identifies sell orders and buy orders to be contract targets based on the information set in the first array and the second array.

In this manner, with the information processing apparatus 100, in the array for managing each of the sell order and the buy order, it is possible to manage the section of order counts of T or F as an element, instead of managing the respective order counts of the available contract (T) or the unavailable contract (F) as elements. Therefore, with the information processing apparatus 100, it is possible to significantly reduce the number of elements of the array for managing each of the sell order and the buy order, and it is possible to reduce calculation cost when obtaining a contract of transaction.

For example, in a case where an operation is performed on elements corresponding to a total order quantity for each one order, the calculation cost (calculation amount) is O (HM) when the total order quantity is H and an order count to be combined is M. Since the information processing apparatus 100 uses the section corresponding to the order count of T or F as the element, an operation is performed on the element for each section for each one order, and thus the calculation cost may be significantly reduced.

In a case of accepting information on a new sell order, the information processing apparatus 100 shifts the first section of the first array based on a sell order count included in this information, and then integrates the first section before the shifting and the first section after the shifting to update the element of the first array. The information processing apparatus 100 associates the information on the new sell order with the element corresponding to the first section after the shift. Therefore, the information processing apparatus 100 may manage the information on the new sell order in the first array in which information on the sell order is already set.

In the association of a price with the element of the first section, the information processing apparatus 100 associates the minimum price among prices included in the information on the sell order with the element. Therefore, the information processing apparatus 100 may manage the sell order in the first array such that a contract may be made at the minimum price.

In a case of accepting information on a new buy order, the information processing apparatus 100 shifts the third section of the second array based on a buy order count included in this information, and then integrates the third section before the shifting and the third section after the shifting to update the element of the second array. The information processing apparatus 100 associates the information on the new buy order with the element corresponding to the third section after the shift. Therefore, the information processing apparatus 100 may manage the information on the new buy order in the second array in which information on the buy order is already set.

In the association of a price with the element of the third section, the information processing apparatus 100 associates the maximum price among prices included in the information on the buy order with the element. Therefore, the information processing apparatus 100 may manage the buy order in the second array such that a contract may be made at the maximum price.

Based on the maximum value in the overlapping section of the first section in the first array and the third section in the second array, the information processing apparatus 100 identifies sell orders and buy orders with the maximum contract count. Therefore, the information processing apparatus 100 may identify the sell orders and the buy orders with the maximum contract count.

In the information processing apparatus 100, the first section and the second section, as well as the third section and the fourth section are half-open sections in which one direction common to each other is a closed section. Therefore, the information processing apparatus 100 may seamlessly manage the first section and the second section, as well as the third section and the fourth section, in the first array and the second array.

Note that each component of each apparatus illustrated in the drawings may not be configured physically as illustrated in the drawings. For example, specific forms of the separation and integration of each apparatus are not limited to those illustrated in the drawings. The entirety or part of the apparatus may be configured by functionally or physically separating into arbitrary units or integrating into an arbitrary unit in accordance with various loads, usage situations, and the like.

All or certain some of the various processing functions of the acquisition unit 151, the setting unit 152, the order identifying unit 153, and the output control unit 154, to be performed in the control unit 150 of the information processing apparatus 100, may be executed in a CPU (or a microcomputer, such as an MPU or a microcontroller unit (MCU)). All or certain some of the various processing functions may be executed on a program analyzed and executed by the CPU (or the microcomputer such as the MPU or the MCU) or may be executed on hardware using wired logic. The various processing functions performed in the information processing apparatus 100 may be executed in such a way that a plurality of computers cooperate with each other via cloud computing.

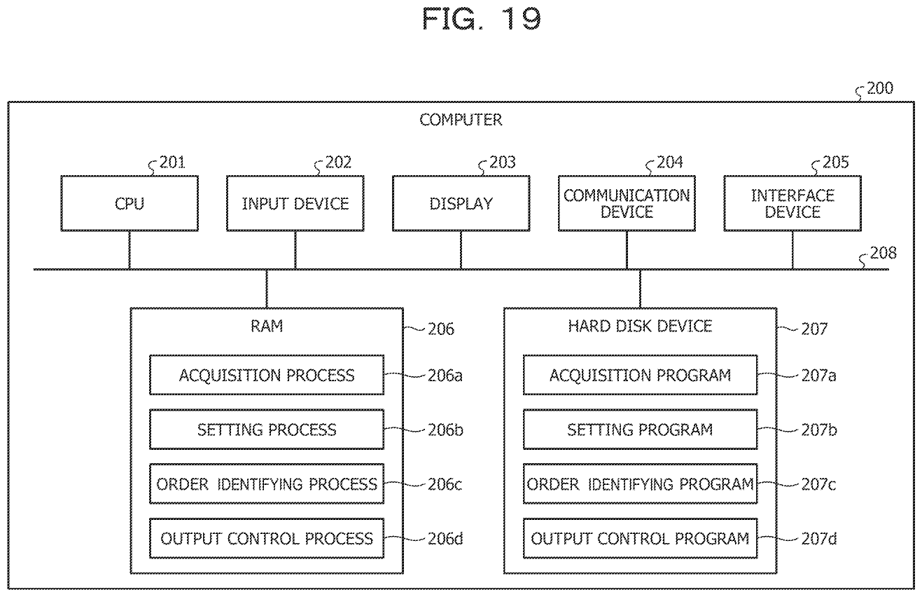

The various processes described in the embodiments described above may be implemented by the computer executing a program prepared in advance. Hereinafter, an example of a computer configuration (hardware) that executes the program having the same functions as in the embodiments described above will be described. FIG. 19 is a diagram illustrating an example of a hardware configuration of a computer that implements a function in the same manner as a function of the information processing apparatus 100 according to the embodiments.

As illustrated in FIG. 19, a computer 200 includes a CPU 201 which executes various operation processes, an input device 202 which accepts input of data from a user, and a display 203. The computer 200 includes a communication device 204 that receives data from an external apparatus, and an interface device 205 that is coupled to various apparatuses. The computer 200 includes a RAM 206 that temporarily stores various types of information, and a hard disk device 207. Each of the CPU 201 to the hard disk device 207 is coupled to a bus 208.

The hard disk device 207 includes an acquisition program 207a, a setting program 207b, an order identifying program 207c, and an output control program 207d. The CPU 201 reads the acquisition program 207a, the setting program 207b, the order identifying program 207c, and the output control program 207d, and develops the programs into the RAM 206.

The acquisition program 207a functions as an acquisition process 206a. The setting program 207b functions as a setting process 206b. The order identifying program 207c functions as an order identifying process 206c. The output control program 207d functions as an output control process 206d.

A process of the acquisition process 206a corresponds to the process of the acquisition unit 151. A process of the setting process 206b corresponds to the process of the setting unit 152. A process of the order identifying process 206c corresponds to the process of the order identifying unit 153. A process of the output control process 206d corresponds to the process of the output control unit 154.

Each program of the acquisition program 207a, the setting program 207b, the order identifying program 207c, and the output control program 207d may not be stored in the hard disk device 207 from the beginning. For example, each program may be stored on a “portable physical medium” such as a flexible disk (FD), a compact disc read-only memory (CD-ROM), a Digital Versatile Disc (DVD), a magneto-optical disc, or an integrated circuit (IC) card to be inserted into the computer 200. Each program may be read and executed by the computer 200. Each program may be stored in a device coupled to a public network, the Internet, a LAN, or the like, and the computer 200 may read and execute each program from the device.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program for causing a computer to execute a process, the process comprising:
setting, based on a sell order count included in information on a sell order, a first array that has elements corresponding to a first section of sell order counts with which a contract is available and a second section of sell order counts with which a contract is unavailable, the information on the sell order being associated with an element corresponding to the first section in the first array;
setting, based on a buy order count included in information on a buy order, a second array that has elements corresponding to a third section of buy order counts with which a contract is available and a fourth section of buy order counts with which a contract is unavailable, the information on the buy order being associated with an element corresponding to the third section in the second array; and
identifying sell orders and buy orders to be contract targets based on the information set in the first array and the second array.

2. The non-transitory computer-readable recording medium according to claim 1, the process further comprising:
shifting, in a case where information on a new sell order is accepted, the first section based on a sell order count included in the information on the new sell order;
integrating the first section before the shifting and the first section after the shifting to update the elements of the first array; and
associating the information on the new sell order with an element corresponding to the first section after the shifting.

3. The non-transitory computer-readable recording medium according to claim 2, the process further comprising:
associating a minimum price among prices included in the information on the new sell order with the element corresponding to the first section after the shifting.

4. The non-transitory computer-readable recording medium according to claim 1, the process further comprising:
shifting, in a case where information on a new buy order is accepted, the third section based on a buy order count included in the information on the new buy order;
integrating the third section before the shifting and the third section after the shifting to update the elements of the second array; and
associating the information on the new buy order with an element corresponding to the third section after the shifting.

5. The non-transitory computer-readable recording medium according to claim 4, the process further comprising:
associating a maximum price among prices included in the information on the new buy order with the element corresponding to the third section after the shifting.

6. The non-transitory computer-readable recording medium according to claim 1, the process further comprising:
identifying, based on a maximum value in overlapping sections of the first and third sections, sell orders and buy orders with a maximum contract count.

7. The non-transitory computer-readable recording medium according to claim 1, wherein
the first section and the second section, as well as the third section and the fourth section are half-open sections in which one direction common to each other is a closed section.

8. A contract method, comprising:
setting by a computer, based on a sell order count included in information on a sell order, a first array that has elements corresponding to a first section of sell order counts with which a contract is available and a second section of sell order counts with which a contract is unavailable, the information on the sell order being associated with an element corresponding to the first section in the first array;
setting, based on a buy order count included in information on a buy order, a second array that has elements corresponding to a third section of buy order counts with which a contract is available and a fourth section of buy order counts with which a contract is unavailable, the information on the buy order being associated with an element corresponding to the third section in the second array; and
identifying sell orders and buy orders to be contract targets based on the information set in the first array and the second array.

9. The contract method according to claim 8, further comprising:
shifting, in a case where information on a new sell order is accepted, the first section based on a sell order count included in the information on the new sell order;
integrating the first section before the shifting and the first section after the shifting to update the elements of the first array; and
associating the information on the new sell order with an element corresponding to the first section after the shifting.

10. The contract method according to claim 9, further comprising:
associating a minimum price among prices included in the information on the new sell order with the element corresponding to the first section after the shifting.

11. The contract method according to claim 8, further comprising:
shifting, in a case where information on a new buy order is accepted, the third section based on a buy order count included in the information on the new buy order;
integrating the third section before the shifting and the third section after the shifting to update the elements of the second array; and
associating the information on the new buy order with an element corresponding to the third section after the shifting.

12. The contract method according to claim 11, further comprising:
associating a maximum price among prices included in the information on the new buy order with the element corresponding to the third section after the shifting.

13. The contract method according to claim 8, further comprising:
identifying, based on a maximum value in overlapping sections of the first and third sections, sell orders and buy orders with a maximum contract count.

14. The contract method according to claim 8, wherein
the first section and the second section, as well as the third section and the fourth section are half-open sections in which one direction common to each other is a closed section.

15. An information processing apparatus, comprising:
a memory; and
a processor coupled to the memory and the processor configured to:
set, based on a sell order count included in information on a sell order, a first array that has elements corresponding to a first section of sell order counts with which a contract is available and a second section of sell order counts with which a contract is unavailable, the information on the sell order being associated with an element corresponding to the first section in the first array;
set, based on a buy order count included in information on a buy order, a second array that has elements corresponding to a third section of buy order counts with which a contract is available and a fourth section of buy order counts with which a contract is unavailable, the information on the buy order being associated with an element corresponding to the third section in the second array; and
identify sell orders and buy orders to be contract targets based on the information set in the first array and the second array.

16. The information processing apparatus according to claim 15, wherein
the processor is further configured to:
shift, in a case where information on a new sell order is accepted, the first section based on a sell order count included in the information on the new sell order;
integrate the first section before the shifting and the first section after the shifting to update the elements of the first array; and
associate the information on the new sell order with an element corresponding to the first section after the shifting.

17. The information processing apparatus according to claim 16, wherein
the processor is further configured to:
associate a minimum price among prices included in the information on the new sell order with the element corresponding to the first section after the shifting.

18. The information processing apparatus according to claim 15, wherein
the processor is further configured to:
shift, in a case where information on a new buy order is accepted, the third section based on a buy order count included in the information on the new buy order;
integrate the third section before the shifting and the third section after the shifting to update the elements of the second array; and
associate the information on the new buy order with an element corresponding to the third section after the shifting.

19. The information processing apparatus according to claim 18, wherein
the processor is further configured to:
associate a maximum price among prices included in the information on the new buy order with the element corresponding to the third section after the shifting.

20. The information processing apparatus according to claim 15, wherein
the processor is further configured to:
identify, based on a maximum value in overlapping sections of the first and third sections, sell orders and buy orders with a maximum contract count.
